(19) United States
(12) Patent Application Publication
(10) Pub. No.: US 2019/0066128 A1
(43) Pub. Date: Feb. 28, 2019

(54) COMPUTER SYSTEM AND METHOD TO PREDICT CUSTOMER BEHAVIOR BASED ON INTER-CUSTOMER INFLUENCES AND TO CONTROL DISTRIBUTION OF ELECTRONIC MESSAGES

(71) Applicants: ORACLE INTERNATIONAL CORPORATION, Redwood Shores, CA (US); MASSACHUSETTS INSTITUTE OF TECHNOLOGY, Cambridge, MA (US)

(72) Inventors: Lennart BAARDMAN, Cambridge, MA (US); Tamar COHEN, Cambridge, MA (US); Setareh BORJIAN BOROUJENI, Burlington, MA (US); Kiran PANCHAMGAM, Bedford, MA (US); Georgia PERAKIS, Cambridge, MA (US)

(21) Appl. No.: 15/685,116

(22) Filed: Aug. 24, 2017

(51) Int. Cl. G06Q 30/02

(52) U.S. Cl. CPC G06Q 30/0202; G06Q 10/067; G06Q 30/0239

(57) ABSTRACT

Systems, methods, and other embodiments associated with predicting customer behavior are described. The method can include identifying a group comprising customers who satisfy a defined criterion, and receiving input that identifies a factor that influences a decision by the customers to purchase a product. A likelihood that the factor will induce the customers in the group to purchase the product is generated. A customer influence on the generated likelihood is estimated independently of data expressly identifying relationships between the customers in the group. The likelihood is modified by combining the likelihood and the customer influence according to a predictive model, and one or more of the customers eligible for a promotional offer related to the product is identified based, at least in part, on the modified likelihood. Transmission of the promotional offer is controlled to transmit the promotional offer to the identified customers in the group.

### BACKGROUND

Many retailers store data pertaining to customer transactions. In addition, retailers may also receive and store customer information, such as gender and age, submitted by customers as a condition of enrolling in loyalty programs. The stored data can be used by retailers to personalize their services for each individual customer. Tailored promotions can be offered to customers for items similar to those that were previously purchased by them. However, tailoring promotions to each individual customer creates logistical difficulties for the retailer.

More recently, the presence of relationships between customers on social networking websites has been used to identify groups of related customers in an effort to categorize the customers into groups. Offers to such groups mitigate the logistical difficulties faced by retailers by lowering the number of tailored promotions that are to be offered. However, group offers are based on the assumptions that the customers necessarily reveal their preferences in social networks and the customers related to each other within a social network are interested in the same products, which is often an incorrect assumption. Further, retail computer systems and social networking websites are often isolated from each other. Without the existence of social-networking connections between customers being expressly defined in the retail computer system, such relationships between customers are not available for use in grouping customers to receive a common promotion.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 schematically illustrates an embodiment of a system for predicting a purchase probability that takes into consideration inter-customer influences.

FIG. 2 illustrates an embodiment of a method associated with controlling transmission of a promotional offer to customers identified based on a predicted purchase probability.

FIG. 3 illustrates an embodiment of a method associated with generating a likelihood that a defined product will be purchased by an identified group of customers based on one or more parameters input by a user.

FIG. 4 illustrates an embodiment of a method associated with estimating a customer influence on a purchase probability.

FIG. 5 illustrates an embodiment of a non-transitory computer-readable medium.

FIG. 6 illustrates an embodiment of a computing system configured with the example systems and/or methods disclosed.

### DETAILED DESCRIPTION

Knowledge of customer interrelationships allows retailers to improve their demand forecasting and targeting of promotions. A customer influence model disclosed herein considers both direct and indirect relationships between customers, even when only transactional data, and no social media data expressly defining such interrelationships, for example, is available. The customer influence model describes how more likely are customers to purchase a product once other customers have already purchased this product previously. In other words, the customer influence model indicates the effect of a purchase history for one group of customers has on the likelihood that another group of customers will purchase a product.

Computerized systems and methods are described herein that determine a purchase probability as a function of, among other variables, the customer influence model. The customer influence model considers an influence that group of customers have on each other in deciding whether to purchase a product. The customer influence is estimated independently of data expressly identifying relationships between groups of customers, such as by limiting the data used to estimate the customer influence to transactional data obtained as a result of previous purchases of the product. Examples of the transactional data include, but are not limited to, time of purchase information, price information, or product information, or optionally demographic information about customers if such information is available. Thus, even if only transactional data is available, the customer influence can be considered in predicting a probability that members of a group will purchase a product.

Embodiments of the present systems and methods estimate the customer influence according to a regularized regression model. In addition to the customer interrelationships, the customer influence model may also optionally take into consideration, as one or more variables, product pricing, seasonality effects, or a factor accounting for a product's popularity. Estimating the customer influence does not require social network data defining relationships between customers as input. Instead, the customer influence model uncovers implicit and interpretable relationships and estimates their strength by using transactional data, and optionally only transactional data. If other sources of data (such as social data and customer click-stream data) are available, the present customer influence model can optionally be supplemented with such data to further improve the predicted purchase probabilities.

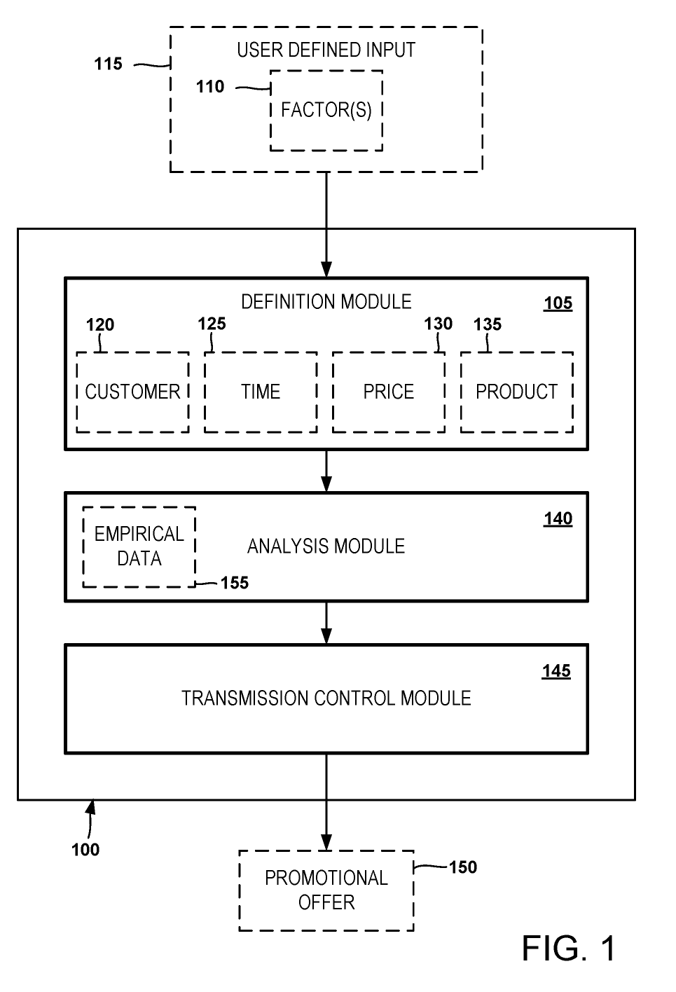

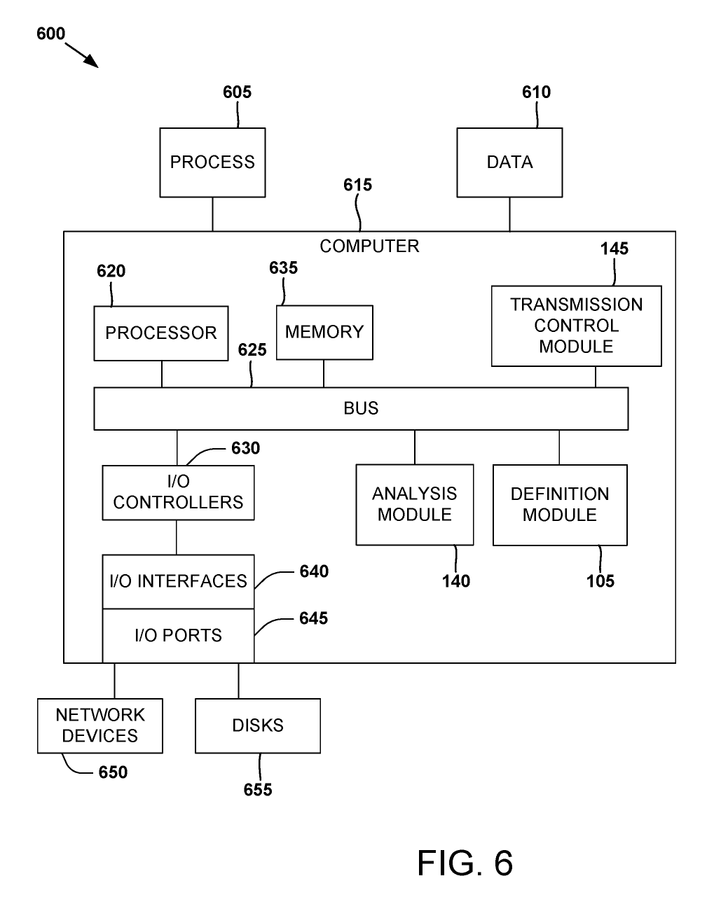

With reference to FIG. 1, one embodiment of a computer system 100 associated with identifying customers eligible for a promotional offer based on a purchase probability, and controlling transmission of the promotional offer in electronic form to remote devices associated with the identified customers is illustrated. The system 100 includes a definition module 105, which can be configured to execute on a computer, such as computer 615 of FIG. 6. The definition module 105 can optionally be provided as part of a user computing device, or communicate with a user computing device and/or hosting platform over a communication network. Regardless of its implementation, the definition module 105 is configured to create a data structure defining parameters based on one or more factors 110 received as input 115 from a user. The user input 115 is received by a receiver optionally implemented as an I/O controller 630 (FIG. 6) of the computer 615, for example, to establish the parameters of a transaction for which the purchase probability is to be determined. The purchase probability is the probability that a product identified in the user input 115 will be purchased by customers identified in the user input 115 during a transaction according to each of the factors 110. The purchase probability considers the influence the customers have on each other as a factor, and this customer influence is determined independently of data expressly identifying relationships between the customers in the group.

The user input 115, including each factor 110, identifies a parameter of the transaction that is to be established by the definition module 105 for performing the methods described herein. For the example shown in FIG. 1, for transactions involving the purchase of one or more products, the user input 115 may include, and the definition module defines: (i) a customer parameter 120, (ii) a time parameter 125, (iii) a price parameter 130, or (iv) a product parameter 135. The customers and the product are specified in the user input 115, and the parameters that influence whether the identified customers purchase the identified products are referred to herein as the factors 110. Each of the above parameters is discussed separately below.

Customer

The customer parameter 120 identifies groups of customers for which the purchase probability is to be predicted for future transactions. The group of customers identified by the customer parameter 120 is identified as part of the user input 115. Customers can be grouped by, for example: (i) location (e.g., customers within a defined zip code), (ii) sex, (iii) membership in a loyalty program, (iv) age (e.g., between the ages of 30 and 40 years old), (v) spending (e.g., those customers who spend at least a threshold amount of money over a defined period), or any other classification that would divide the full customer population into at least two subgroups of customers. For example, if customer parameter 120 identifies customer groups as groups of men and groups of women who reside in each of the three zip code (44131, 44132, and 44133), then there will be six groups of customers, for each of which the purchase probability is to be predicted for future transactions. In other words, the purchase probability will be predicted for men who reside in zip code 44131, women who reside in zip code 44131, men who reside in zip code 44132, women who reside in zip code 44132, men who reside in zip code 44133, and women who reside in zip code 44133.

Time

The time parameter 125 identifies a period of time or periods of time over which the purchase probability is to be predicted. The time parameter 125, as identified by the factors 110, can be indicative of a season during which the purchase probability is applicable. For example, the factors 110 may limit the applicability of the purchase probability for winter clothing to the autumn or winter seasons, or to three different periods of time (early season, mid-season and late season) in winter. Embodiments of the time can include: (i) a range or number of days, weeks, months, years, etc.; (ii) holiday seasons (e.g., Christmas season); (iii) solstice and equinox seasons (e.g., winter, spring, summer, autumn); or any other time-related classification. Depending on the time-related classification, there can be one or more periods of time for which the purchase probability is to be predicted. For example, if time parameter 125 identifies time periods as early/mid/late season in winter and spring, then there will be six periods of time, for each of which the purchase probability is to be predicted for future transactions.

Price

The price parameter 130 is indicative of whether a promotion will be in effect for the product during the period of time corresponding to the time parameter 125. The price parameter 130 is based on the factors 110 input by the user, and can include: (i) an upper or lower price limit (e.g., prices up to $50, prices above $20, prices between $50 and $100); (ii) a discount (e.g., 25% off of a regular price); (iii) a Boolean data structure (e.g., regular price (false or 0) or promotional price (true or 1)); or any other price-related classification. Depending on the price-related classification, there can be two or more different levels of price for which the purchase probability is to be predicted. For example, if price parameter 130 identifies price levels as regular price and promotional price, then there will two levels of price, for each of which the purchase probability is to be predicted for future transactions.

Product

The product parameter determined based on the user input 115 identifies one product or a group of products for which the purchase probability is to be predicted. The product parameter 135 can identify one product, a plurality of products, or a class of products. For example, the product parameter 135 can be associated with: (i) a product category (e.g., men's tops, women's dress shoes); (ii) specific styles within a product category (e.g., solid colors, pinstripes, short sleeves); or any other product-related classification.

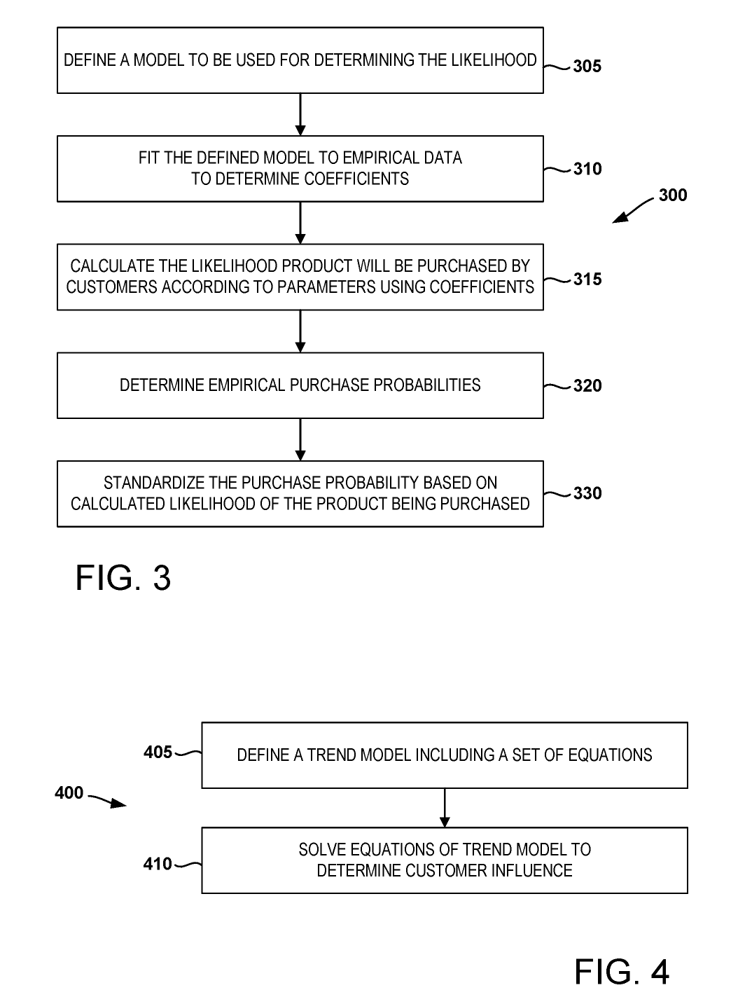

With continued reference to FIG. 1, the system 100 also includes an analysis module 140, which can be configured to execute on a computer, such as computer 615 of FIG. 6. The analysis module 140 can optionally be provided as part of a user computing device, or communicate with a user computing device and/or hosting platform over a communication network. Regardless of its implementation, the analysis module 140 is configured to generate a likelihood that the price or time corresponding to the price parameter 130 or the time parameter 125, respectively, will induce customers to purchase the product corresponding to the product parameter 135. The likelihood is generated by the analysis module 140 based on a predictive model that has been fit to empirical transactional data collected during previous purchases of the product, as described in detail below with reference to FIG. 3. The transactional data to which the predictive model for determining the likelihood is fit can include data indicating how often the product was previously purchased when one or more of the parameters were in effect.

The analysis module 140 can also be configured to estimate a customer influence on the likelihood generated by the analysis module 140. The customer influence is indicative of the influence the customers identified by the customer parameter 120 have on each other in deciding whether to purchase the product. The customer influence is estimated by the analysis module 140 independently of data expressly identifying relationships between the customers in a group (e.g., without social-networking data expressly identifying relationships between the customers in the group). In other words, the data used by the analysis module 140 to generate the customer influence does not necessarily have to be link data that expressly identifies relationships between the customers in the group on a social-networking website. For example, a database 155 of empirical transactional data accessible to the analysis module 140 can be used to generate the customer influence as described herein. The transactional data includes, at least time of purchase information, price information, and product information. It can also optionally include demographic information about customers, if such information is available. The link data can be excluded by the analysis module 140 from the estimation of the customer influence. The estimated customer influence is then used by the analysis module 140 to modify the generated likelihood, resulting in a purchase probability that considers the customer influence without the need for link data expressly identifying relationships between the customers.

The database 155 is shown in the embodiment appearing in FIG. 1 as being included as part of the system 100. However, the database 155 according to another embodiment can be arranged externally of the system 100, operatively connected to the system 100 via a network connection.

Based on the purchase probability obtained by modifying the likelihood using the customer influence, the analysis module 140 can identify one or more customers as being eligible for a promotional offer 150 or other benefit. The analysis module 140 is configured to identify customers eligible for the promotional offer 150 based on the determined purchase probability. For example, a group of customers that has high purchase probability relative to another group of customers when offered a promotion for a specific product, and is most likely to influence the purchase decision of other groups of customers in subsequent periods of time can be identified as eligible for the promotional offer 150 for that product. The other groups can be excluded from eligibility for the promotional offer.

A transmission control module 145 is also provided to the system 100, and can be configured to execute on a computer, such as the computer 615 of FIG. 6. The transmission control module 145 can optionally be provided as part of a hosting platform over a communication network. Regardless of its implementation, the transmission control module 145 is configured to limit the transmission of the promotional offer 150 to those eligible customers identified by the analysis module 140. Controlling transmission of the promotional offer 150 according to some embodiments can include transmitting information about the promotional offer 150 over a communication network (e.g., the Internet) as an email, text sent via a cellular communication network, or other type of electronic transmission. Some embodiments of controlling transmission of the promotional offer 150 can include transmitting a data structure including information indicative of those eligible customers to a storage destination where a user computer can access the data structure. By accessing the data structure, the promotional offer 150 can be printed in hardcopy form and sent via a postal service, private courier, or other delivery entity.

In one embodiment, the system 100 is a computing/data processing system including an application or collection of distributed applications for enterprise organizations. The applications and computing system 100 may be configured to operate with or be implemented as a cloud-based networking system, a software as a service (SaaS) architecture, or other type of networked computing solution. In one embodiment the system 100 is a centralized server-side application that provides at least the functions disclosed herein and that is accessed by many users via computing devices/terminals communicating with the computing system 100 (functioning as the server) over a computer network.

In one embodiment, one or more of the components or modules described herein are configured as program modules stored in a non-transitory computer readable medium. The program modules are configured with stored instructions that when executed by at least a processor cause the computing device to perform the corresponding function(s) as described herein.

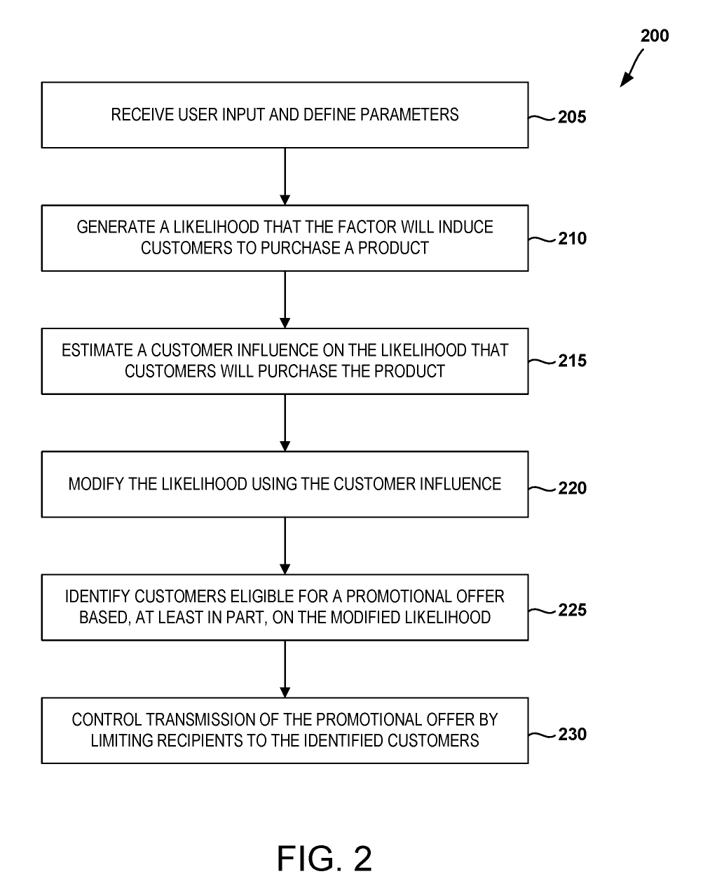

FIG. 2 illustrates one embodiment of a method 200 associated with identifying customers eligible for a promotional offer 150 and controlling transmission of the promotional offer 150 to the eligible customers. The illustrated embodiment of the method 200 is performed by the system 100 of FIG. 1, and may be initiated when a targeted promotional campaign is being developed by a retailer. As shown in FIG. 2, the embodiment of the method 200 includes receiving user input 115 including one or more of the factors 110, and defining a data structure identifying the parameters for the analysis at 205. For the embodiment shown in FIG. 1, the parameters defined by the definition module 105 based on the user input include the customer parameter 120, the time parameter 125, the price parameter 130 and the product parameter 135. Although the system and method are described herein utilizing these four parameters as an example, any parameters can be selected for use with a compatible model to predict the purchase probability without departing from the scope of the present disclosure.

The analysis module 140 can be configured to employ a demand model such as a linear, logistic, log-linear, multiplicative, etc. to fit to the empirical data in the database 155, for example, to generate the likelihood at 210. A detailed description of generating the likelihood is discussed below with reference to FIG. 3.

At 215, the customer influence indicative of the influence the customers corresponding to the customer parameter 120 have on each other is determined. The customer influence is estimated by the analysis module 140 without including, as a factor, data expressly identifying relationships between the customers in a group (e.g., without social-networking data expressly identifying relationships between the customers in the group). Such link data, if available, is excluded by the analysis module 140 from consideration in generating the customer influence.

The estimated customer influence is used by the analysis module 140 at 220, to modify the likelihood generated at 210. This modification results in a purchase probability that considers the customer influence without relying on link data expressly identifying relationships between the customers. For example, the customer influence can be added, optionally in combination with purchase probability that are estimated at 210 based on input parameters 205 and empirical data obtained from the database 155 for previous transactions, according to Expression (1), as follows:

$${b}_{cktr} = {q}_{cktr} + {\sum }_{{c}^{′} \neq c} {\sum }_{{t}^{′} < t} {\sum }_{{r}^{′} = 0 , 1} {p}_{{c}^{′} c} ( {r}^{′} ) {b}_{{c}^{′} {kt}^{′} {r}^{′}} + {ϵ}_{cktr} , \qquad ( 1 )$$

for all customer groups c, all time periods t, and all price levels r that are identified based on parameters 120, 125 and 130.

In Expression (1), b is the empirical purchase probability (with combined effects of parameters based on one or more factors 110 and the customer influence), q is the base purchase probability (based only on the effects of one or more parameters such as customer, time, price and product), p is the customer influence, and E is the systematic model error. Influence probability p_{c′c}(r′), is the influence by customer group c′ on the likelihood that the customers in group c will be induced to purchase the product. This influence probability depends on whether the influencer c′ has purchased the product at full price or discounted price.

The subscripts of b indicate the product(s) and the customer-related, time-related and price-related classifications. Depending on the classifications identified by customer parameter 120, there is two or more groups of customer for which the purchase probability is to be predicted. Similarly, depending on time parameter 125 and price parameter 130, there is one or more periods of time and one or more price levels for which the purchase probability is to be predicted. So Expression (1) is in fact a collection of expressions, each of which predicting purchase probability for one customer/time/price group of interest identified by the values of subscripts.

More specifically, the subscript c represents the customer groups identified by the customer parameter 120 for which the purchase probability is to be predicted. A specific value of subscript c represents the customer group of interest and the subscript c′ represents each of the customer groups other than the customer group of interest, involved in previous transactions for which the empirical data is available from the database 155. For example, the customer parameter may define customer-related classification as men who reside within each of the three zip codes 44131, 44132 and 44133, resulting in three groups of customers. If customer group of interest in Expression (1) is men who resides in zip code 44131, then the designation c′ represents the two other groups of customers (i.e., men who reside within the zip code 44132 and 44133) who were involved in the historical transactions for which empirical data was used from the database 155 to derive the models discussed herein. Thus, historical probabilities of the product being purchased, for example, can be determined for customers in the group of interest, or for other customers excluded from that group.

Similarly, the subscript t represents the periods of time indicated by the time parameter 125. A specific value of subscript t in Expression (1) represents the time period of interest for which the purchase probability is to be predicted, and the designation t′ represents each of the other periods previous to time period of interest. For example, if the time parameter 125 identifies three periods of time as early, mid and late season in winter and the time period of interest in Expression (1) is late season, then t′ represents periods of early season and mid-season in winter.

The subscript k identifies the product(s) corresponding to the product parameter 135. Because the current embodiment of the method is predicting the purchase probability for the product(s) based on previous transactions involving the same product(s), the subscript remains k and does not have an equivalent value for the other product or other groups of product. In other words, the subscript k′ is not used.

The subscript r corresponding to the price parameter 130 indicates the availability of a promotion for the product identified by the letter k. The designation r′ indicates whether a promotion was available for the product identified by the letter k to customer group identified by the letter c′ during the previous transactions for which empirical data is available in the database 155. According to one embodiment, the subscript r or r′ can be assigned a Boolean value of 0 to indicate the absence of a promotional offer for the product, or a Boolean value of 1 to indicate that a promotional offer is applicable to the product.

The analysis module 140 (FIG. 1) may identify one or more customers (e.g., a group of customers) as being eligible for the promotional offer 150 at a given time period based on the purchase probability or the customer influence at 225. For example, the analysis module 140 may predict the purchase probability for the product corresponding to product parameter 135, based on the time parameter 125 and price parameter 130. However, different customer parameters 120 identifying different groups of customers can be used with Expression (1) to predict the purchase probability for each of the different groups of customers. For example, the purchase probability can be predicted for a plurality of different customer groups. Customer parameter 120 can be assigned a different value for each group, such as groups of women between the ages of: 11-20, 21-30, 31-40, and so on. The analysis module 140 can limit those customers who are deemed to be eligible for the promotional offer 150 for the product at a given time period to those groups with the highest predicted purchase probability during the time in question and at the specified price, and with highest influence on other groups in subsequent periods of time.

At 230, the transmission control module 145 controls transmission of the promotional offer 150 to devices (e.g., a user computers, cellular telephones, servers hosting email accounts, etc.) associated with those eligible customers identified by the analysis module 140. Controlling transmission of the promotional offer can include initiating or otherwise contributing to the composition of an electronic communication such as an email or other message structure. The transmission control module 145 optionally can be controlled by the analysis module 140 to address and transmit electronic communications to only those customers included in a group determined to be eligible for the promotional offer 150. According to one embodiment, the transmission control module 145 can control transmission of the promotional offer by creating a data structure including a plurality of customers included in a group determined to be eligible for the promotional offer 150. In one embodiment, physical delivery of a hardcopy description of the promotional offer to each customer in the eligible group can thereafter be performed based on the list of eligible customers.

FIG. 3 illustrates one embodiment of a method 300 associated with generating the likelihood at 210 in FIG. 2. According to the embodiment illustrated in FIG. 3, a predictive model is defined, at 305, for determining the likelihood that the customers will purchase the product based on one or more of the parameters. The predictive model can optionally be a function of a single parameter, or as a function of a plurality, or all of the parameters. The predictive model should assume that the customers do not influence the decisions of the other customers to purchase the product, and is a function of one or more of the parameters (e.g., customer, time, price or product). Thus, the predictive model indicates the likelihood of a purchase being attributable to each of the individual parameters based on a predictive model that is also independent of customer influences.

Any analytic model suitable to be fit to empirical data in the database 155 indicating a historical probability that customers corresponding to the customer parameter 120 purchased the product can be defined. For example, empirical data exhibiting a generally linear distribution may warrant the use of a linear model. Other examples of suitable models include, but are not limited to any demand model such as logistic, log-linear, multiplicative, etc. As an example, the logistic regression model shown in Expression (2) is defined according to one embodiment for determining the likelihood that the customers will purchase the product based on the price and time parameters:

$${q}_{cktr} = \frac{exp ( {x}_{cktr}^{T} β )}{1 + exp ( {x}_{cktr}^{T} β )} \qquad ( 2 )$$

Where x_{cktr}^{T} represents the parameters associated with the transactions for which the purchase probability is being predicted, and the superscript T indicates a transposition of the column vector x_{cktr} into a row vector. For example, x_{cktr}^{T} can include one or more values indicating a season corresponding to the time parameter 125; a style, brand or trend corresponding to the product parameter 135; a promotion corresponding to the price parameter 130, etc. The Greek letter β in Expression (2) is a coefficient to be determined for each parameter to achieve the best fit of the defined model to the empirical data in the database 155.

After the model has been defined, the model is fit to the empirical data in the database 155 at 310 in FIG. 3. The model is fit to empirical data in the database 155 corresponding to each of the parameters (e.g., customer, time, price, product). Fitting the model and applying a statistical technique such as maximum-likelihood estimation, for example, allows for the determination of the values of the coefficient β for each of the parameters, The estimated values of coefficients are represented by \hat{β}. Rewriting Expression (2) in vector notation, the likelihood for each of: the customer parameter 120, the time parameter 125, the price parameter 130 and the product parameter 135 under consideration, can be predicted at 315 according to Expression (3):

$${\hat{q}}_{cktr} = \frac{exp ( {x}_{cktr}^{T} \hat{β} )}{1 + exp ( {x}_{cktr}^{T} \hat{β} )} \qquad ( 3 )$$

At 320, the empirical purchase probability, represented as b_{cktr} and b_{c′kt′r′} in Expression (1), is determined for each of: the customer parameter 120, the time parameter 125, the price parameter 130 and the product parameter 135 under consideration based on the empirical data in the database 155 for previous purchases of the product. Unlike the likelihood, discussed above, the empirical purchase probability can be determined based solely on the empirical data in the database 155, without use of a predictive model for predicting the purchase probability for future transactions, as was done to generate the likelihood as discussed above. Thus, the empirical purchase probability can indicate the fraction of the previous transactions during a defined time period involving a purchase of the product, according to a price corresponding to the price parameter, by the customers.

The standardized purchase probability b_{cktr}^{s} can be expressed as the difference between the empirical purchase probability in Expression (1) and the likelihood in Expression (3). For example, the standardized purchase probability b_{cktr}^{s} may be determined at 330 according to Expression (4):

b_{cktr}^{s}=b_{cktr}−q_{cktr} (4)

FIG. 4 illustrates a method 400 associated with the analysis module 140 estimating a customer influence independently of data expressly identifying relationships between the customers in a group (e.g., without social-networking data expressly identifying relationships between the customers in the group). In other words, the data used by the analysis module 140 to generate the customer influence can be any data other than link data that identifies any established relationships between the customers in the group on a social-networking website, or any other network. Excluding the link data from the estimation of the customer influence allows the customer influence to be considered in predicting the purchase probability according to expression (1), and can avoid the need to establish an interface between the system 100 and a social-networking website.

A trend model can be established at 405 to include a number of equations that is equal to a number of unknowns. According to one example, the collection of equations can include: (i) a regularized least square optimization model with the goal of minimizing the error while constraining the resulting values of inter-customer influences, (ii) a rearrangement of Expression (1) in view of Expression (4), and (iii) the bounds of the customer influence value between zero (0) and one (1), inclusive. The set of expressions according to the present example can be expressed as:

$$\begin{matrix}min {\sum }_{c} {\sum }_{k} {\sum }_{t} {\sum }_{r} {ϵ}_{cktr}^{2} + λ {\sum }_{( {c}^{′} , c )} {p}_{{c}^{′} c} & ( 5 ) \\ {ϵ}_{cktr} = {b}_{cktr}^{S} - {\sum }_{{c}^{′} \neq c} {\sum }_{{t}^{′} < t} {\sum }_{{r}^{′} = 0 , 1} {p}_{{c}^{′} c} ( {r}^{′} ) {b}_{{c}^{′} {kt}^{′} {r}^{′}} ∀ c , k , t , r & ( 6 ) \\ 0 \leq {p}_{{c}^{′} c} \leq 1 ∀ {c}^{′} , c & ( 7 )\end{matrix}$$

Where λ is a coefficient that corresponds to the trade-off between minimizing the value of error E and constraining the summation of values of customer influences. The customer influence value between zero (0) and one (1) between customer groups considered in the analysis indicates the influence at least one of those groups has on the likelihood that another of those groups will purchase the product. For example, between two different groups A and B, the closer the customer influence value is to zero (0), the less of an influence group A has on the likelihood that group B will purchase the product. A customer influence value equal to zero (0) indicates there is no influence, and a customer influence value equal to (1) indicates that the purchase history by group A will lead to group B purchasing the product.

Simultaneously solving expressions (5)-(7) at 410 using the regularized least squares technique, for example, results in the value for the customer influence p_{c′c} and the error ϵ_{cktr}. The values of customer influence p_{c′c} and the estimated values of q_{cktr} obtained from expression (2), can be inserted into expression (1) for generating the likelihood b_{cktr} for a future transaction. In such a format, Expression (1) can be used to estimate the likelihood that the customers will purchase the product according to Expression (2). Expression (1) also involves modifying the likelihood with the customer influence to predict the purchase probability of the customers for future transactions involving the product, during the time and at the price corresponding to the time and price parameters 125, 130, respectively.

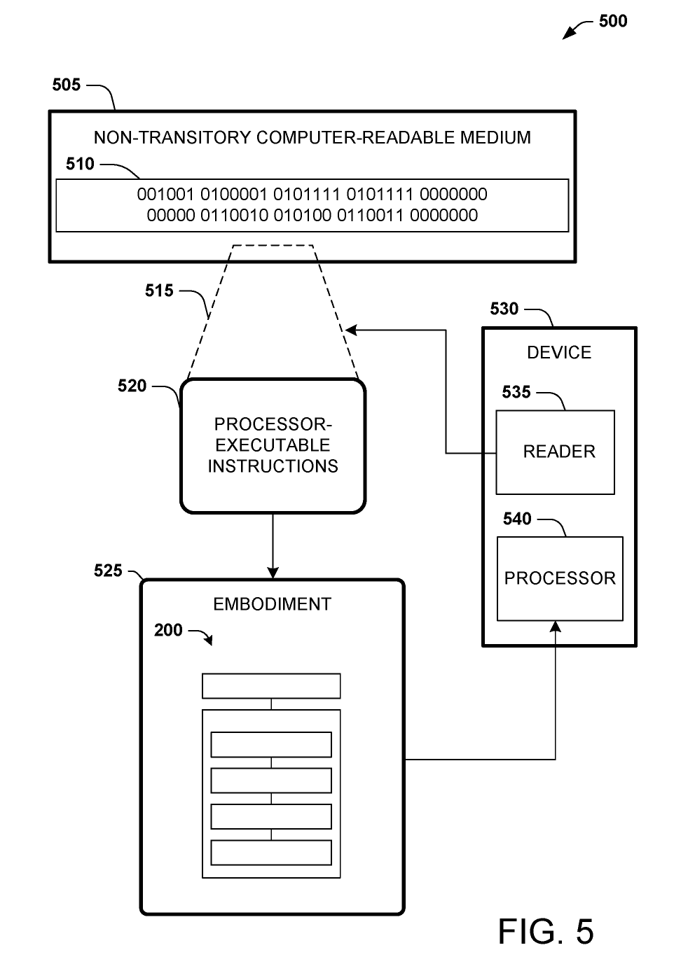

FIG. 5 is a schematic illustration of a scenario 500 involving an example non-transitory computer-readable medium 505. In one embodiment, one or more of the components described herein are configured as program modules, such as the analysis module 140, stored in the non-transitory computer-readable medium 505. The program modules are configured with stored instructions, such as processor-executable instructions 520, that when executed by at least a processor, such as processor 540, cause the computing device to perform the corresponding function(s) as described herein. In one embodiment, the, functionality of the definition module 105, the analysis module 140, or the transmission control module 145, stored in the non-transitory computer-readable medium 505, may be executed by the processor 540 as the processor-executable instructions 520 to perform an embodiment 525 of the method 200 of FIG. 2.

The non-transitory computer-readable medium 505 includes the processor-executable instructions 520 that when executed by a processor 540 cause performance of at least some of the provisions herein. The non-transitory computer-readable medium 505 includes a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory computer-readable medium 505 stores computer-readable data 510 that, when subjected to reading 515 by a reader 535 of a device 530 (e.g., a read head of a hard disk drive, or a read operation invoked on a solid-state storage device), express the processor-executable instructions 520.

In some embodiments, the processor-executable instructions 520, when executed cause performance of operations, such as at least some of the example method 200 of FIG. 2, for example. In some embodiments, the processor-executable instructions 520 are configured to cause implementation of a system, such as at least some of the example system 100 of FIG. 1, for example.

FIG. 6 illustrates an example computing device 600 that is configured and/or programmed with one or more of the example systems and methods described herein, and/or equivalents. The example computing device 600 may be the computer 615 that includes a processor 620, a memory 635, and I/O ports 645 operably connected by a bus 625. In one embodiment, the, the computer 615 may include logic of the definition module 105, the analysis module 140, or the transmission control module 145 configured to facilitate the system 100 and/or the method 200 shown in FIGS. 1-2. In different embodiments, the logic of the analysis module 140 may be implemented in hardware, a non-transitory computer-readable medium 605 with stored instructions, firmware, and/or combinations thereof. While the logic of the definition module 105, the analysis module 140, or the transmission control module 145 is illustrated as a hardware component attached to the bus 525, it is to be appreciated that in other embodiments, the logic of the definition module 105, the analysis module 140, or the transmission control module 145 could be implemented in the processor 620, stored in memory 635, or stored in disk 655.

In one embodiment, logic of the definition module 105, the analysis module 140, the transmission control module 145, or the computer 515 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application specific integrated circuit (ASIC) programmed to implement rule based source sequencing for allocation. The means may also be implemented as stored computer executable instructions that are presented to computer 615 as data 610 that are temporarily stored in memory 635 and then executed by processor 620.

The logic of the definition module 105, the analysis module 140, or the transmission control module 145 may also provide means (e.g., hardware, non-transitory computer-readable medium 605 that stores executable instructions, firmware) for performing rule based source sequencing for allocation.

Generally describing an example configuration of the computer 615, the processor 620 may be a variety of various processors including dual microprocessor and other multi-processor architectures. The memory 635 may include volatile memory and/or non-volatile memory. Non-volatile memory may include, for example, read-only memory (ROM), programmable read-only memory (PROM), and so on. Volatile memory may include, for example, random access memory (RAM), static random-access memory (SRAM), dynamic random access memory (DRAM), and so on.

The disks 655 may be operably connected to the computer 615 via, for example, the I/O interface 640 (e.g., card, device) and the I/O ports 645. The disks 655 may be, for example, a magnetic disk drive, a solid state disk drive, a floppy disk drive, a tape drive, a Zip drive, a flash memory card, a memory stick, and so on. Furthermore, the disks 655 may be a CD-ROM drive, a CD-R drive, a CD-RW drive, a DVD ROM, and so on. The memory 635 can store a process, such as within the non-transitory computer-readable medium 605, and/or data 610, for example. The disk 655 and/or the memory 635 can store an operating system that controls and allocates resources of the computer 615.

The computer 615 may interact with input/output (I/O) devices via the I/O interfaces 640 and the I/O ports 645. The I/O devices may be, for example, a keyboard, a microphone, a pointing and selection device, cameras, video cards, displays, the disks 655, the network devices 650, and so on. The I/O ports 645 may include, for example, serial ports, parallel ports, and USB ports. I/O controllers 630 may connect the I/O interfaces 640 to the bus 625.

The computer 615 can operate in a network environment and thus may be connected to the network devices 650 via the I/O interfaces 640, and/or the I/O ports 645. Through the network devices 650, the computer 615 may interact with a network. Through the network, the computer 615 may be logically connected to remote computers (e.g., the computer 615 may reside within a distributed computing environment to which clients may connect). Networks with which the computer 615 may interact include, but are not limited to, a local area network (LAN), a new area network (WAN), and other networks.

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium storing computer-executable instructions that, when executed by at least a processor of a computer, cause the computer to:
define, by at least the processor, a data structure identifying a group comprising customers who satisfy a defined criterion;
receive, by at least the processor, input that identifies a factor that influences a decision by the customers to purchase a product;
generate, by at least the processor using a predictive model, a predictive purchase probability as a function of:
(i) a likelihood that the factor will induce the customers in the group to purchase the product, and
(ii) a customer influence indicating an influence the customers in the group will have on each other in deciding to purchase the product;
identify, by at least the processor, at least a portion of the group as being eligible for a promotional offer related to the product based, at least in part, on the corrected likelihood; and
control, by at least the processor using a network communication, transmission of one or more electronic messages including content of the promotional offer to remote devices associated with the identified portion of the group that is eligible for the promotional offer.

2. The non-transitory computer-readable medium of claim 1, wherein the customer influence is estimated based on transactional data obtained as a result of previous purchases of the product, wherein the transactional data comprises: time of purchase information, price information, product information or demographic information about customers.

3. The non-transitory computer-readable medium of claim 1, wherein the customer influence is estimated independently of data expressly identifying relationships between the customers in the group.

4. The non-transitory computer-readable medium of claim 1 further comprising instructions that, when executed by at least the processor, cause the computer to:
generate, by at least the processor, a standardized purchase probability based on a difference between the likelihood and an empirical purchase probability, wherein the empirical purchase probability is a historical probability of the product being purchased by the customers in the group.

5. The non-transitory computer-readable medium of claim 4, wherein the customer influence is estimated based on the standardized purchase probability.

6. The non-transitory computer-readable medium of claim 4, further comprising instructions that, when executed by at least the processor, cause the computer to define a period of time when purchases occurred for determining the historical probability.

7. The non-transitory computer-readable medium of claim 1, wherein the predictive model is further a function of a historical probability of the product being purchased by the customers in the group or by other customers excluded from the group.

8. A computing system, comprising:
at least one processor connected to at least one memory comprising a non-transitory computer readable medium;
a definition module stored on the memory and including instructions that, when executed by the at least one processor, cause the computing system to define a data structure identifying a group comprising customers who satisfy a defined criterion;
a receiver that receives input that identifies a factor that influences a decision by the customers to purchase a product;
an analysis module stored on the memory and including instructions that, when executed by the at least one processor, cause the computing system to generate a predictive purchase probability using a predictive model that is a function of:
(i) a likelihood that the factor will induce the customers in the group to purchase the product, and
(ii) a customer influence indicating an influence the customers in the group will have on each other in deciding to purchase the product;
wherein the analysis module further includes instructions that, when executed by the at least one processor, cause the computing system to identify a portion of the group as being eligible for a promotional offer related to the product based, at least in part, on the corrected likelihood; and
a control module stored on the memory and including instructions that, when executed by the at least one processor, cause the computing system to, using a network communication, control transmission of one or more electronic messages including content of the promotional offer to remote devices associated with the identified portion of the group that is eligible for the promotional offer.

9. The computing system of claim 8, wherein the analysis module estimates the customer influence based on transactional data obtained as a result of previous purchases of the product, the transactional data comprising: demographic information about customers, time of purchase information, price information, or product information.

10. The computing system of claim 8, wherein the analysis module estimates the customer influence independently of data expressly identifying relationships between the customers in the group.

11. The computing system of claim 8, wherein the analysis module further includes instructions that, when executed by the at least one processor, cause the computing system to generate a standardized purchase probability based on a difference between the likelihood and an empirical purchase probability, wherein the empirical purchase probability is a historical probability of the product being purchased by the customers in the group.

12. The computing system of claim 11, wherein the analysis module estimates the customer influence based on the standardized purchase probability.

13. The computing system of claim 11, wherein the definition module further includes instructions that, when executed by the at least one processor, cause the computing system to define a period of time when purchases occurred for determining the historical probability.

14. The computing system of claim 8, wherein the instructions of the analysis module define the predictive model as a function of a historical probability of the product being purchased by the customers in the group or by other customers excluded from the group.

15. A computer-implemented method, the method comprising:
defining a data structure identifying a group comprising customers who satisfy a defined criterion;
receiving input that identifies a factor that influences a decision by the customers to purchase a product;
generating, using a predictive model, a predictive purchase probability as a function of:
(i) a likelihood that the factor will induce the customers in the group to purchase the product, and
(ii) a customer influence indicating an influence the customers in the group will have on each other in deciding to purchase the product;
identifying a portion of the group as being eligible for a promotional offer related to the product based, at least in part, on the corrected likelihood; and
controlling, using a network communication, transmission of one or more electronic messages including content of the promotional offer to remote devices associated with the identified portion of the group that is eligible for the promotional offer.

16. The method of claim 15, wherein the customer influence is estimated based on transactional data obtained as a result of previous purchases of the product, wherein the transactional data comprises: demographic information about customers, time of purchase information, price information, or product information.

17. The method of claim 15, wherein, wherein the customer influence is estimated based on data other than link data that expressly identifies relationships between the customers in the group.

18. The method of claim 15 further comprising generating a standardized purchase probability based on a difference between the likelihood and an empirical purchase probability, wherein the empirical purchase probability is a historical probability of the product being purchased by the customers in the group

19. The method of claim 18, wherein the customer influence is estimated based on the standardized purchase probability.

20. The method of claim 15, wherein said estimating the customer influence comprises calculating the customer influence exclusively on the transactional data.
